(19) United States
(12) Patent Application Publication
(10) Pub. No.: US 2010/0036774 A1
(43) Pub. Date: Feb. 11, 2010

(54) Method for User Registration with a Proxy for Further Work with One of the Server Units

(76) Inventor: Olexandr Vityaz, Donetsk (UA)

Correspondence Address: Adams and Reese LLP, 1221 McKinney Street, Suite 4400, Houston, TX, 77010, US

(21) Appl. No.: 12/579,018

(22) Filed: Oct. 14, 2009

Related U.S. Application Data
(63) Continuation of application No. 10/582,819, filed on Apr. 13, 2007.

(30) Foreign Application Priority Data
Dec. 18, 2003 (UA) 20031211806

(51) Int. Cl. G06Q 40/00

(52) U.S. Cl. 705/76

(57) ABSTRACT

The invention relates to digital data processing to be used in commercial application. A method for user registration with a proxy for further work with one of the server units comprises an establishing a protected link by a proxy between a user registration control bank server (UR) via the bank's processing center with respective remote banking or financial user card serving terminals (UCST), link of the bank's issued card database server (BICD) with the bank's processing center, and between the user registration control bank server (UR) and at least one of the server units, herein the user get at least one set of code symbols after registration, which is also sent to at least one of the server units for further user identification in it in case of his requesting said server unit, the user is registered and given at least one set of code symbols at a respective remote banking or financial user card serving terminals (UCST) in which the card's details are entered for further verification at the bank's issued card database server (BICD), and the user registration control bank server (UR) immediately transmits the user registration details to the respective server unit. Alternatively registration with the use of the BICD server of a respective bank card issuer is performed.

### STATEMENT OF RELATED CASES

The present application is a continuation of U.S. Non-Provisional application Ser. No. 10/582,819 filed Apr. 13, 2007, still pending.

### FIELD OF THE INVENTION

The present invention is related to digital data processing to be used in commercial application, and to a method for user registration with a proxy for further work with one of the server units in particular.

### STATE OF THE PRIOR ART

The closest to the prior art in terms of technical characteristics and results achieved is a method for user registration with a proxy for further work with one of the server units, which is disclosed on a web-page with the URL: http://www.alfabank-express.ru/remoteaccess/ibank/. According to this method a user is to turn directly to the bank in order to procure a registration. A bank employee identifies the user by his documents and bank accounts straight in the bank's branch and registers the user, that is, enters the user's personal details into the processing center of the bank and gives him at least one set of code symbols which is also sent at least to one server unit. Further, the user addresses via above mentioned terminal to one of the server units in order to get requested service with the use of said set of code symbols. According to other embodiment the bank employee gives the user three sets of code symbols: login, password, and session key. The login is a universal identifying means of the user's access to a corresponding server unit. The password is issued in a sealed envelope and later can be changed by the user in process of further work with the relevant server unit. A session key is a one-shot password used in some banking operations.

The main shortcoming of this method for a user registration with a proxy for further operation with a server unit is impossibility of using an immediate registration or re-registration of a user caused by a necessity for the user to visit the bank, so much time and labor inputs being wasted by the bank personnel in order to perform that registration or a further re-registration of the user in order to increase the security level in remote operation with one of a number of server units.

The aim of present invention is a providing of an effective method of a user's registration to be served remotely by means of an immediate registration or re-registration of a user at remote banking or financial user card serving terminals, which allows to save time and labor inputs for registration, and its completion in the electronic form and in real time mode. This allows an increase of the protection level and, at the same time, immediate re-registration of the user for remote operation with one out of a number of server units.

### SUMMARY OF THE INVENTION

According to the method for a user registration with a proxy for further operation with one of the server units, said task is solved by providing protected connection to the proxy between the user registration control bank server (UR) and a corresponding remote banking or financial user card serving terminals (UCST) via the bank's processing center, connection of the bank's issued card database server (BICD) with the bank's processing center, as well as with at least one server unit, and, at that, the user is to get at least one set of code symbols after registration, which is sent at least to one server unit for further user identification in case of the user's addressing that server unit. At that, the user is registered and issued at least one set of code symbols by a relevant remote banking or financial user card serving terminal (UCST) wherein the card's details are entered for further verification at the bank's issued card database server (BICD), and the user registration control bank server (UR) performs an immediate transmission of the user's registration details to a corresponding server unit. Besides, to ensure registration of the user of card issued by another bank a verification of the card's details is performed at the bank's issued card database server (BICD) of the bank that issued said card.

User's registration and issuing of at least one set of code symbols at a remote banking or financial user card serving terminals (UCST) into which the details of the user's card are entered for further verification at the bank's issued card database server (BICD), while the user registration control bank server (UR) performs an immediate transmission of the user's registration details to a corresponding server unit, assures registration and identification of the user automatically in real time mode and in the electronic form via protected communication lines and immediately in the banking or financial user card serving terminal (UCST). This allows reduction of time and labor inputs spent for a user's registration. Besides, that provides for immediate re-registration of a user in order to increase the level of protection in remote operation with one out of a number of server units.

Registration of a user whose card has been issued by another bank card issuer, with verification of the card's details at the bank's issued card database server (BICD) of the bank that issued said card, enables the use for registration of a user a wider range of cards issued by various bank card issuers, including cards of international payment system.

The above-said confirms the presence of the cause and effect relation between the totality of the features of invention and the technical result achieved.

Said totality of the features ensures registration of a user immediately at a remote banking or financial user card serving terminal (UCST), as compared with the closest prior art solution, that, in its turn, allows a full electronic and automatic registration in real time mode. This also results in reduction of time and labor inputs for registration and provides for immediate re-registration of a user to increase security during remote operation with one of the server units. Besides, an availability and status of the user's account is verified during such registration.

The author believes that disclosed invention meets the “novelty” and “inventive step” criteria, because the totality of the features of invention, characterizing the present method for a user's registration with a proxy for further operation with one of server units, is new and does not obviously result from the prior art.

### BRIEF DESCRIPTION OF THE DRAWINGS

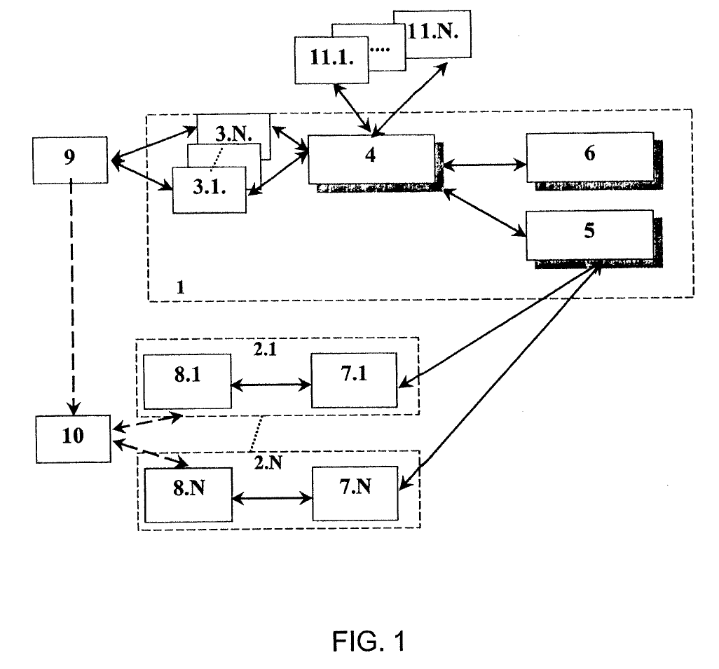

The present invention is disclosed below with the reference to the block schematic diagram in FIG. 1 that represent the method for user registration with a proxy for further operation with one of several server units.

### DETAILED DESCRIPTION OF A PREFERRED EMBODIMENT

The method for user registration with a proxy for further work with one of the server units may be implemented as follows.

A user requests a proxy via a remote banking or financial user card serving terminal (UCST) which has a protected link via the bank's processing center, selects the required service for further work with one of the server units, herein the card's details are entered into that terminal, and this user card serving terminal (UCST) generates and sends a request via the bank's processing center for verification of the issued cards in the bank's issued card database server (BICD) in case the card has been issued by the same bank. On the verification of the request, the user registration control bank server (UR) sends the user at least one set of code symbols via the bank's processing center to a corresponding banking or financial user card serving terminal (UCST). This set of code symbols is sent to at least one server unit for further identification of the user in case of its contacting one of the server units.

In case the bank's processing center identifies the card has been issued by another bank card issuer, the card's details verification will be performed at the bank's issued card database server (BICD) of the corresponding card issuing bank; the same refers to cards of international payment systems.

If there is a reason to suspect an unauthorized use of sets of code symbols obtained during registration, immediate re-registration of the user may be possible.

The best embodiment of a system according to present invention as shown in the FIG. 1 includes a proxy 1 as an appropriate bank equipment and a number of server units 2.1-2.N. The proxy 1 includes a number of respective banking or financial user card serving terminals (UCST) 3.1-3.N, which are connected by means of a protected communication link via the bank's processing center 4 with the user registration control bank server (UR) and bank's issued card database server (BICD). Each of a number of server units 2.1-2.N includes respective servers of the registered users' databases 7.1-7.N, which have their own systems of remote user service (RUS) 8.1-8.N, for example: Internet-banking, GSM-banking, other systems using Internet and mobile communication etc. The user 9 contacts via his terminal 10 or another terminal with one of selected server units 2.1-2.N via the corresponding remote user service (RUS) 8.1-8.N. A number of the bank's issued card database servers (BICD) 11.1-11.N of respective bank card issuer including international payment systems, for example, Visa, MasterCard is connected to the bank's processing center 4. The banking and financial user card serving terminals (UCST) 3.1-3.N are any terminals capable of supporting plastic card transactions, including international payment system cards. The 3.1.-3.N. terminals can be made in the form of automatic teller machines (ATM), POS-terminals, etc. The bank's processing center 4 is a software/hardware combination intended to serve the bank equipment with a card transaction database. The user registration control bank server (UR) 5 is a software/hardware combination which follows a set of algorithms or parameters to assure automatic registration of a user of available server units 2.1-2.N services, which represent billing systems or corresponding remote service systems with respective databases of registered users.

A system in which the method for user registration with a proxy for further work with one of the server units is implemented operates as follows.

A user 9 requests the bank's proxy 1, particularly one (respective) of number of banking and financial user card serving terminals (UCST) 3.1-3.N in which the user inserts his card and enters the personal identification number (PIN) of the card. The user chooses the necessary service out of the number of accessible remote server units 2.1-2.N. The corresponding user card serving terminal (UCST) out of the number of the user card serving terminals (UCST) 3.1-3.N verifies the card's PIN and generates a request to the bank's processing center 4 which determines if the card belongs to a certain payment system, and it also identifies the bank card issuer, the type of service which the user 9 would like to get later and amount of money for the registration withdrawn from user's 9 bank account are recorded.

Herein if the card has been issued by the same bank, i.e. by the proxy 1, and which the respective user card serving terminal (UCST) out of number 3.1-3.N belongs to, which the user 9 has contacted, the bank's processing center 4 routes the requests to the bank's issued card database server (BICD) 6. This bank's issued card database server (BICD) 6 performs verification of the availability and status of the user's 9 account, withdraws money for re-registration and provides additional user 9 details if they are necessary for registration at the respective server unit 2.1-2.N. The bank's processing center 4 also sends details to the user registration control bank server (UR) 5 which are necessary for registration of the user 9 with the respective server unit 2.1-2.N. The user registration control bank server (UR) 5 verifies absence of data for refusal of registration and, in case of their absence, it generates the first (Login) and the second (Password) sets of code symbols, which are transmitted to a respective servers of the registered users' databases 7.1-7.N of the respective server unit out of number 2.1-2.N, which has been selected by the user 9. They are also transmitted via the bank's processing center 4 to a respective banking or financial user card serving terminal (UCST) out of number 3.1-3.N in order for them to be either displayed on a monitor or printed on paper (bill/receipt) for the user 9.

In case of there being a reason to refuse registration with a respective servers of the registered users' databases out of number 7.1-7.N, the user registration control bank server (UR) 5 sends the refusal of the user's 9 registration via the bank's processing center 4 to the respective banking or financial user card serving terminal (UCST) 3.1-3.N.

In case the bank's processing center 4 determines that the card belongs to another bank card issuer or payment system, the bank's processing center 4 sends a request of banking or financial user card serving terminal (UCST) 3.1-3.N to a respective bank's issued card database server (BICD) out of number 11.1-11.N of the respective bank card issued, including cards of international payment systems. This bank's issued card database server (BICD) verifies the availability and status of the user's 9 account, registration money is withdrawn, and additional data are obtained if they are necessary for the user's 9 registration with the respective server unit 2.1-2.N. Then the bank's processing center 4 sends these data to the user registration control bank server (UR) 5, which generates and sends the first and second sets of code symbols to the respective server of the registered users' databases 7.1-7.N and, via the bank's processing center 4 to a respective banking or financial user card serving terminal (UCST) out of number 3.1-3.N the same way as described above.

On completion of registration, the user 9 connects the respective remote user service (RUS) system 8.1-8.N of the respective server of the registered users' databases 7.1-7.N of the server unit 2.1-2.N. by means of the one's terminal (personal computer, mobile telephone or another terminal) and receives the required service.

Conformity of the present invention to the invention criterion “commercial applicability” is confirmed by the disclosed method for user registration with the proxy for further work with one of server units.

1. A method for user registration with a proxy for further work with one of the server units is based on establishing a protected link by a proxy between a user registration control bank server (UR) via the bank's processing center with respective remote banking or financial user card serving terminals (UCST), link of the bank's issued card database server (BICD) with the bank's processing center, and between the user registration control bank server (UR) and at least one of the server units, herein after registration the user gets at least one set of code symbols, which is also sent to at least one of the server units for further user identification in said server unit in case of routing user's request to said server unit, wherein the user is registered and given at least one set of code symbols at a respective remote banking or financial user card serving terminals (UCST) in which the card's details are entered for further verification at the bank's issued card database server (BICD), and the user registration control bank server (UR) immediately transmits the user registration details to the respective server unit.

2. The method according to claim 1, wherein a card detail verification of a user, whose card has been issued by another bank, is performed by the bank's issued card database server (BICD) in order to register the user.
